(19) United States
(12) Patent Application Publication
(10) Pub. No.: US 2012/0199534 A1
(43) Pub. Date: Aug. 9, 2012

(54) DESALINATION METHODS

(75) Inventors: Mark T. Holtzapple, College Station, TX (US); George A. Rabroker, College Station, TX (US); Li Zhu, College Station, TX (US); Jorge H.J. Lara Ruiz, College Station, TX (US); Somsak Watanawanavet, College Station, TX (US)

(73) Assignees: TERRABON ADVE, LLC, Houston, TX (US); The Texas A&M University System, College Station, TX (US)

(21) Appl. No.: 13/191,125

(22) Filed: Aug. 17, 2011

Related U.S. Application Data
(62) Division of application No. 11/870,174, filed on Oct. 10, 2007, now abandoned.
(60) Provisional application No. 60/828,882, filed on Oct. 10, 2006.

(51) Int. Cl. C02F 1/04; C02F 1/42

(52) U.S. Cl. 210/664; 203/11; 203/10

(57) ABSTRACT

In accordance with particular embodiments, a desalination system includes a plurality of evaporators. The plurality of evaporators includes at least a first evaporator and a last evaporator. The plurality of evaporators are arranged in cascading fashion such that a concentration of salt in a brine solution increases as the brine solution passes through the plurality of evaporators from the first evaporator towards the last evaporator. The desalination system also includes a plurality of heat exchangers. An input of each evaporator is coupled to at least one of the plurality of heat exchangers. The system also includes a vapor source coupled to at least one of the plurality of evaporators.

### CROSS-REFERENCE TO RELATED APPLICATIONS

This application claims benefit under 35 U.S.C. §119(e) to U.S. Provisional Application Ser. No. 60/828,882 filed Oct. 10, 2006 by Holtzapple, et al., and entitled Desalination System, which is hereby incorporated by reference.

### TECHNICAL FIELD OF THE INVENTION

This invention relates generally to desalination systems, and more particularly, to a desalination system using a cascading series of evaporators.

### BACKGROUND OF THE INVENTION

In order to recover potable or desalinated water from salt water, desalination systems have been devised. Although many differing types of designs have been used, evaporation systems using the thermodynamic property of vapor pressure of water have become widely accepted. This is principally due to the relatively high purity of water produced by the vaporization process. One system involves the use of a single heat exchanger that takes vapor from one end of the heat exchanger, puts it through a compressor and than back into the heat exchanger on the other side. This may be referred to as a single-effect evaporator. The disadvantage of a single-effect evaporator is that the pressure difference is very small (e.g, a compression ratio of 1.03 or 1.05 to 1). Thus the compressor is basically functioning as a blower and not really a compressor. Furthermore, all distilled water produced by the system had to go as vapor through the blower.

### SUMMARY OF THE INVENTION

In accordance with particular embodiments, a desalination system includes a plurality of evaporators. The plurality of evaporators includes at least a first evaporator and a last evaporator. The plurality of evaporators are arranged in cascading fashion such that a concentration of salt in a brine solution increases as the brine solution passes through the plurality of evaporators from the first evaporator towards the last evaporator. The desalination system also includes a plurality of heat exchangers. An input of each evaporator is coupled to at least one of the plurality of heat exchangers. The system also includes a vapor source coupled to at least one of the plurality of evaporators.

Depending on the specific features implemented, particular embodiments of the present invention may exhibit some, none, or all of the following technical advantages. Various embodiments may be capable of providing an improved desalination process from seawater or brackish water. The disclosed embodiments describe a cascaded-type evaporation process for salt water that efficiently uses varying vapor pressures in order to efficiently utilize energy or work that is put into the system. Accordingly, distilled water is removed in stages which may reduce the amount of work needed to remove the distilled water.

Additionally, certain embodiments may provide a cascading-type desalination system that is relatively inexpensive to construct as well as to maintain.

Other technical advantages will be readily apparent to one skilled in the art from the following figures, description, and claims.

### BRIEF DESCRIPTION OF THE DRAWINGS

A more complete understanding of particular embodiments may be apparent from the detailed description taken in conjunction with the accompanying drawings in which:

FIG. 1 is a schematic diagram of a desalination system using a single vapor source, in accordance with particular embodiments;

FIG. 2 is a schematic diagram of another desalination system using a single vapor source, in accordance with particular embodiments;

FIG. 3 is a schematic diagram of a desalination system using multiple vapor sources, in accordance with particular embodiments;

FIG. 4 is a schematic diagram of another desalination system using multiple vapor sources, in accordance with particular embodiments;

FIG. 5A is a side elevational cross-sectional view of one embodiment of a compressor that may be used with the embodiments of FIGS. 1 through 4;

FIG. 5B is a front elevational view of one embodiment of a propeller that may be used with the compressor of FIG. 5A;

FIG. 5C is a front elevational view of one embodiment of a ducted fan that may be used with the compressor of FIG. 5A;

FIG. 6 is a schematic diagram of another desalination system using multiple jet ejectors as vapor sources, in accordance with particular embodiments;

FIG. 7 is a schematic diagram of another desalination system using multiple jet ejectors as vapor sources, in accordance with particular embodiments;

FIG. 8 is a schematic diagram of another desalination system using multiple jet ejectors as vapor sources, in accordance with particular embodiments;

FIG. 9A is a side elevational cross-sectional view of one embodiment of a jet ejector that may be used with the embodiments of FIGS. 6 through 8;

FIG. 9B is a side elevational cross-sectional view of another embodiment of a jet ejector that may be used with the embodiments of FIGS. 6 through 8;

FIG. 9C is a side elevational cross-sectional view of another embodiment of a jet ejector that may be used with the embodiments of FIGS. 6 through 8;

FIG. 9D is a front cross-sectional view along line 192 of FIG. 9C;

FIG. 10A is a plan cross-sectional view of an evaporator, in accordance with particular embodiments;

FIG. 10B is a side elevation cross-sectional view of an evaporator, in accordance with particular embodiments;

FIG. 11 is a front elevation cross-sectional view of an evaporator, in accordance with particular embodiments;

FIG. 12A is a perspective view of the cassettes and jet ejectors used within an evaporator, in accordance with particular embodiments;

FIG. 12B is a front elevational cross-sectional view of the jet ejectors of FIG. 12A;

FIG. 13A is a front elevational view of a heat exchanger plate that may be used to form a portion of one of the cassettes of FIG. 12A;

FIG. 13B is a front elevational view of the heat exchanger plate of FIG. 13A with the edges bent along the dotted lines of the heat exchanger plate shown in FIG. 13A;

FIG. 13C is a side elevational cross-sectional view of the heat exchanger plate of FIG. 13B;

FIG. 13D is a side elevational cross-sectional view of the heat exchanger plate of FIG. 13B;

FIG. 14A is a front elevational view of a another heat exchanger plate that may be used to form a portion of one of the cassettes of FIG. 12A;

FIG. 14B is a front elevational view of the heat exchanger plate of FIG. 14A with the edges bent along the dotted lines of the heat exchanger plate shown in FIG. 14A;

FIG. 14C is a side elevational cross-sectional view of the metal sheet of FIG. 14B;

FIG. 14D is a side elevational cross-sectional view of the metal sheet of FIG. 14B;

FIG. 15A is a partial perspective view of a cassette assembly, in accordance with particular embodiments;

FIG. 15B is a partial enlarged perspective view of FIG. 15A showing the tabs that are formed on the edges;

FIG. 15C is a enlarged partial side elevational view of FIG. 15A;

FIG. 16A is a partial perspective view of another cassette assembly, in accordance with particular embodiments;

FIG. 16B is a partial enlarged perspective view of FIG. 16A showing the edges;

FIG. 16C is an enlarged partial side elevational view of FIG. 16A;

FIG. 17A is an enlarged partial plan view of two heat exchanger plates that are assembled together shown with dimples having flat surfaces;

FIG. 17B is an enlarged partial plan view of two heat exchanger plates that are assembled together shown with depressions in several of the dimples;

FIG. 18A is an enlarged partial plan view of two heat exchanger plates that have been joined together using a welded joint;

FIG. 18B is a partial plan view of two heat exchanger plates that have been joined together using a brazed joint;

FIG. 18C is a partial plan view of two heat exchanger plates that have been joined together using a crimp clamp;

FIG. 18D is a partial plan view of two heat exchanger plates that have been joined together using a crimp clamp, wherein the edges of the heat exchanger plates are raised so the crimp clamp is securely held in place;

FIG. 18E is a partial plan view of two heat exchanger plates that have been joined together using a rivet or screw;

FIG. 18F is a partial plan view of two heat exchanger plates that have been joined together using an extended tab that is integrally formed on the edge of one heat exchanger plate;

FIG. 19 is a schematic diagram of a desalination system using an ion exchange system, in accordance with particular embodiments;

FIG. 20 is a schematic diagram of a desalination system using an abrasive material, in accordance with particular embodiments;

FIG. 21 is a schematic diagram of a desalination system using an abrasive material and a precipitate material, in accordance with particular embodiments;

FIG. 22 is a schematic diagram of a desalination system in which the vapor leaving the final evaporator is condensed and discharged, in accordance with particular embodiments;

FIG. 23 is a schematic diagram of another desalination system in which the vapor leaving the final evaporator is condensed and discharged, in accordance with particular embodiments;

FIG. 24 is a schematic diagram of a desalination system using two vapor sources in which the vapor leaving the final evaporator is condensed and discharged, in accordance with particular embodiments; and

FIG. 25 is a schematic diagram of a desalination system in which the vapor leaving the initial evaporator is condensed and discharged, in accordance with particular embodiments; and

FIG. 26 is a graph showing the overall heat transfer coefficient as a function of condensing-side temperature and the overall temperature difference between the condensing steam and boiling water.

### DETAILED DESCRIPTION OF SEVERAL EMBODIMENTS

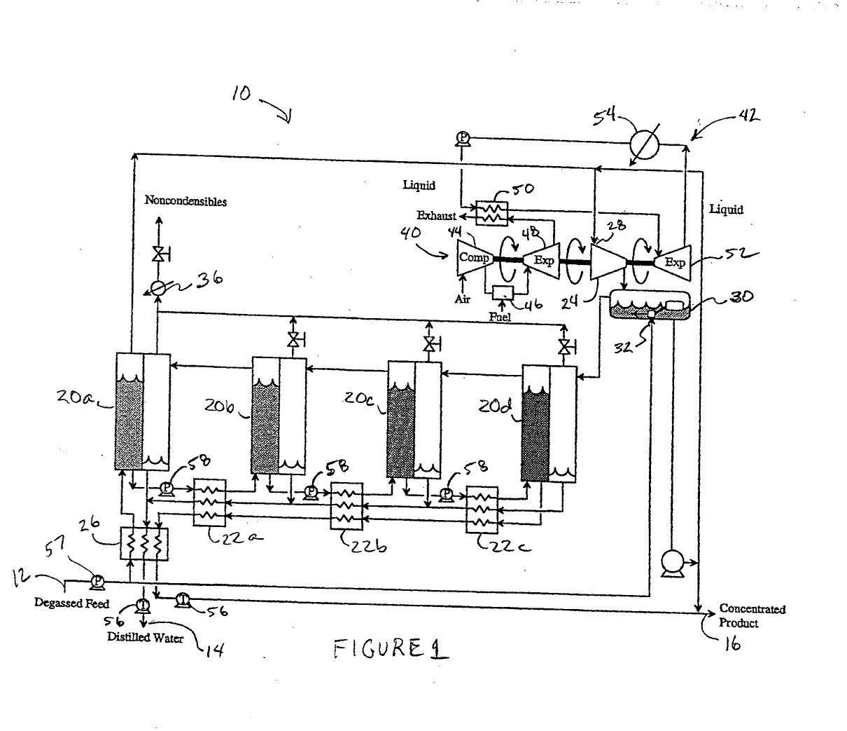

Referring now to the drawings, FIG. 1 is a schematic diagram of a desalination system using a single vapor source, in accordance with particular embodiments. The desalination system 10 is adapted to accept salt water at a degassed feed input 12, distill at least a portion of distilled water from the salt water, and provide distilled water at distilled water output line 14 and concentrated brine at concentrated brine output line 16. The water desalination system 10 has several water evaporators 20, several heat exchangers 22 that are coupled in between each of the water evaporators 20, and a compressor 24 that is coupled to each of the water evaporators 20. The compressor 24 is coupled to each of the water evaporators 20 in a cascading fashion such that each successive water evaporator 20 has a relatively lower operating pressure and temperature than the upstream water evaporator 20. In this manner, water may be progressively removed or evaporated from the salt water.

The condensing steam in the upstream water evaporator 20 causes more steam to boil off from the salt water. This steam cascades to the next downstream water evaporator 20 where it condenses and vaporizes more water. Thus, as the steam progresses from evaporator 20d towards evaporator 20a its temperature decreases and as the salt water progresses from evaporator 20a towards evaporator 20d the salt concentration increases. Accordingly, the higher temperature steam is used to vaporize the more concentrated salt water whereas the less concentrated salt water is vaporized with cooler steam. This takes advantage of the relative ease (and correspondingly less work) of extracting water from less concentrated salt water. The temperature difference between the evaporators can be as small as a fraction of a degree. In some embodiments the temperature difference between water evaporators 20 is between one and six degrees Fahrenheit.

As shown, degassed salt water is introduced into the degassed water feed input 12 and into a countercurrent heat exchanger 26 that has concentrated brine and distilled water flowing in the opposite direction. Heat exchanger 26 may help to preheat the brine solution before it enters evaporator 20a. The degassed salt water enters a first water evaporator 20a where a portion of the water vaporizes. The remaining salt water, which is now at a higher salt concentration than it was at the degassed feed 12, is pumped through a countercurrent heat exchanger 22a into the second water evaporator 20b where additional water is vaporized. The countercurrent heat exchanger 22a helps to heat salt water before it enters water evaporator 20b, which is at a higher temperature and pressure than water evaporator 20a. This process is repeated as many times as desired. In FIG. 1, a total of four water evaporators 20a, 20b, 20c, and 20d are shown; however, any number of water evaporators 20 may be used. By using four evaporators, or four stages, for each pound of steam introduced into water evaporator 20d four pounds of liquid (the distilled water 14) product may be generated. Thus, the initial energy is recycled four times so that the heat of condensation of that steam coming in is supplied to each of the four water evaporators 20. Another advantage of the four stages is that only a fourth of the vapor used by water evaporators actually goes through the compressor 24. Thus the compressor 24 can be one-fourth the size of a compressor needed for a single-stage desalination system.

Salt water vaporized from the first heat exchanger 20a enters the inlet 28 of the compressor 24. If desired, atomized liquid water can be added to the compressor inlet 28 to keep the compressor 24 cool. This may help to prevent the vapor from superheating. Because the compressor 24 is compressing against each of the four stages the compression ratio is much higher than if there was only a single-stage (for each additional stage the total compression ratio is multiplied by the compression ratio for that additional stage). A traditional compressor will typically superheat when compressing at higher compression ratios. This may require more energy to be put into the system to overcome the superheated vapor than would be needed for non-superheated vapor. This is based on the notion that the hotter the gas in the compressor the more energy that is needed to compress it. Thus, in particular embodiments, rather than letting the vapor superheat, liquid is sprayed into the compressor to keep it on the saturation curve and avoid superheating. The liquid sprayed into the compressor may be salt water or distilled water depending on operational needs, desires, or preferences. As may be apparent by introducing water into the compressor 24, some of the water may vaporize, thus creating additional vapor that may be condensed. Because, in the illustrated embodiment, it is salty water that is being fed to the compressor 24 not only does the water help keep the compressor 24 cool, but it also desalinates some salt water at the same time. Thus, as may be apparent the compressor 24 may not only be able to handle vapor but also liquid. For example, in particular embodiments a gerotor compressor available from StarRotor Corporation may be used.

If excess liquid water is added to the compressor 24, the excess may be removed into a knock-out drum 30. A portion of the degassed feed 12 may also be fed into the knock-out drum 30. This supply of liquid may be used to spray the compressor 24. While the depicted knock-out drum 30 is shown with salt water, in other embodiments the knock-out drum may be filled with distilled water.

The atomized water may be any type of water. In one embodiment, the atomized water may be salt water. As water evaporates in the compressor 24, the salt concentration increases. A portion of this concentrated salt must be purged from the system, and is recovered as concentrated product from the concentrated brine output line 16. New degassed feed 32 is added to make up for the concentrated salt that is purged from the knock-out drum 30. One function of the knock-out drum 30 may be to keep the salty water that is sprayed into the compressor 24 from entering water evaporator 20d with the vapor that is condensing therein.

High-pressure vapor exiting the compressor 24 is fed to the evaporator 20d operating at the highest pressure. This vapor being supplied to the evaporator 20d may be of a higher temperature than the vapor supplied to evaporator 20c. As these vapors condense, they cause water to evaporate from the salt water. These vapors, which are at a lower temperature than the vapors that fed the evaporator 20d, are passed to the next water evaporator 20c, which is operated at a lower pressure, where they condense. This process is repeated for all of the other evaporators 20b and 20a configured in the system. While the vapors generally move from evaporator 20d towards evaporator 20a, progressively cooling at each step, the degassed feed 12 supplies salt water that generally moves from evaporator 20a towards evaporator 20d. As the salt water moves towards evaporator 20d, the salt concentration gradually increases as the water evaporates. When the salt water finally leaves evaporator 20d, it is relatively concentrated and at a relatively high temperature. This hot concentrated fluid then passes through the heat exchangers 22 and 26 before being expelled as the concentrated product 16. As it passes through the heat exchangers 22 and 26, the concentrated product is cooled down. The heat that is removed from the concentrated product is used to increase the temperature of the salt water that is entering the respective water evaporators 20. Depending on the needs of the operator of desalination system 10, either the concentrated product 16 and/or the distilled water 14 may be collected for later use.

Any noncondensibles (e.g., air or gases) that enter with the degassed feed input line 12 must be purged from the system. As shown in FIG. 1, it is assumed that all heat exchangers operate above 1 atmosphere (atm), so the noncondensibles can be directly purged. If the system were operated below 1 atmosphere, a vacuum pump (not specifically shown) may be needed to remove the noncondensibles. In either case, a condenser 36 is located before the purge so that water vapor can be recovered before the noncondensibles are removed. In some embodiments, the noncondensibles may be purged from the desalination system as a slow trickle that ultimately is vented to the outside world. The heat condenser 36 ensures that any water vapor that may be mixed in with the noncondensibles is recovered before the noncondensibles are vented. If the desalination system is operated at high pressure, energy can be recovered in turbines 56. This energy can be re-invested in the pump 57 used to pressurize the degassed feed 12.

The compressor 24 can be driven by any motive device such as an engine or an electric motor. In FIG. 1, the compressor 24 is driven by a combined cycle gas turbine such as a Brayton cycle engine 40 and a Rankine cycle engine 42. In the Brayton cycle engine 40, air is compressed using an air compressor 44, fuel is added to the compressed air in a combustion chamber 46 and combusted, and the hot high-pressure gas is expanded through an expander 48. The exiting low-pressure gas is very hot and can be used to vaporize a liquid in the Rankine engine during its bottoming cycle, which in this case, is a heat exchanger 50.

In the Rankine cycle engine 42, a high-pressure fluid is heated in heat exchanger 50. The hot high-pressure fluid expands in an expander 52 where work is extracted. The vapor exiting the expander 52 is condensed to a liquid in a condenser 54, which is then pumped back to heat exchanger 50.

Ideally, the Rankine expander 52 allows liquid to condense in the expander 52 during the expansion process. If this occurs, it reduces the heat load on the condenser 54, it shrinks the physical size of the expander 52, and it allows the cycle to be more efficient because some of the latent heat is converted to work. In one embodiment, may be a gerotor expander. In another embodiment, the gerotor expander may be available from StarRotor Corporation, located in Bryan, Tex.

In principle, many Rankine fluids can be used; however, some fluids are better than others. A fluid should be selected that is above the supercritical pressure when entering the expander and is below the supercritical pressure when exiting the expander. By selecting a fluid that is above the supercritical pressure when entering the expander (e.g., methanol), there are only sensible heat changes in the fluid as it countercurrently extracts thermal energy from the exiting exhaust gas from the Brayton cycle. This allows the approach temperature to be very uniform through the heat exchanger, which increases system efficiency. If the fluid undergoes latent heat changes in the high-temperature heat exchanger, large approach temperatures are required in the heat exchanger, which lowers system efficiency.

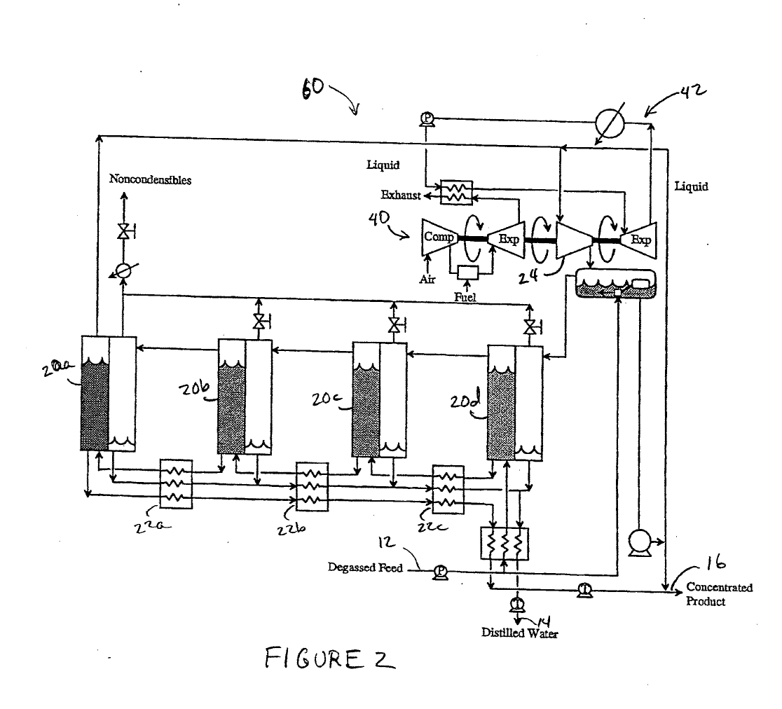

FIG. 2 is a schematic diagram of another desalination system using a single vapor source, in accordance with particular embodiments. The degassed feed input 12, water output line 14, concentrated brine output line 16, water evaporators 20, heat exchangers 22, compressor 24, Brayton cycle engine 40, and Rankine cycle engine 42 are similar to the embodiment of FIG. 1. The desalination system 60 differs however in that the degassed feed input 12 is coupled to evaporator 20d that is operating at the highest pressure and temperature. This embodiment may be desirable where the degassed feed has components with reverse solubility characteristics. For example, calcium carbonate becomes less soluble as it becomes hotter.

As may be apparent, by introducing the degassed feed at evaporator 20d, the concentration of the salt water decreases as it moves from water evaporator 20d towards water evaporator 20a. This is the opposite of how the salt concentration changed between evaporators 20 in FIG. 1. However, the temperature and pressure still increase from the left-most water evaporator 20a to the right-most water evaporator 20d.

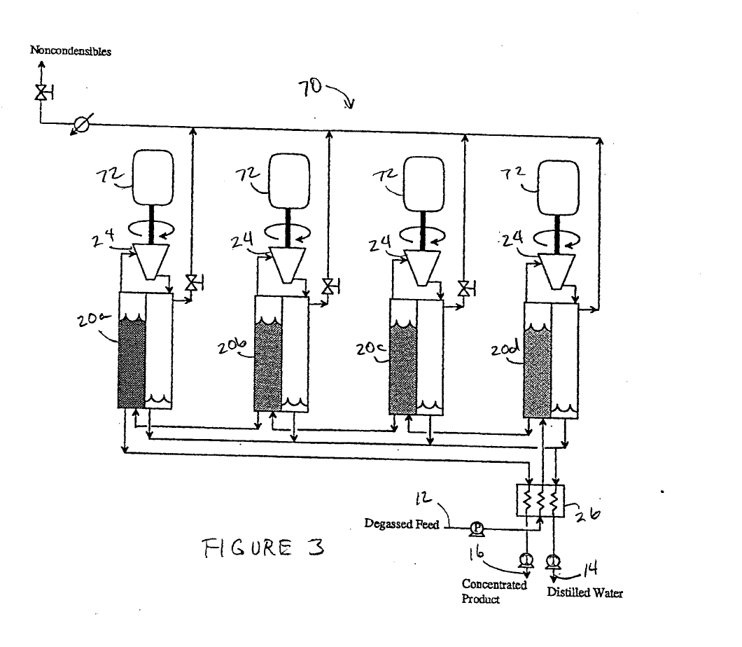

FIG. 3 is a schematic diagram of a desalination system using multiple vapor sources, in accordance with particular embodiments. The desalination system 70 is similar to the desalination system 10 of FIG. 1 in that desalination system 70 also uses a series of evaporators 20, each operating at a different salt concentration. In this particular embodiment however, each evaporator 20 has its own dedicated compressor 24. In this case, it is possible for each evaporator to operate at nearly identical temperatures, which may eliminate the need for heat exchangers between each evaporator stage. The compressors shown in FIG. 3 may be driven by any means; in this case, electric motors 72 are shown. Similar to the previous embodiments, the salt concentration is slowly increasing as it passes through each evaporator. Accordingly, the solution is the most heavily concentrated at evaporator 20a and the least heavily concentrated at water evaporator 20d. Thus, it may be that the compressor 24 servicing water evaporator 20a may have the hardest job because it is working with the most heavily concentrated solution. In some embodiments compressors 24 may very efficient at low compression ratios of 1.05 or 1.03 to one.

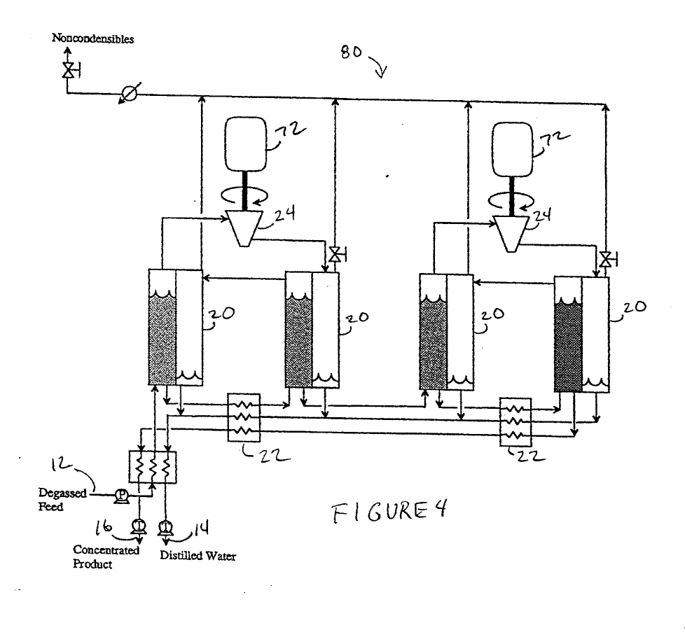

FIG. 4 is a schematic diagram of another desalination system using multiple vapor sources, in accordance with particular embodiments. The desalination system 80 is similar to the desalination system 70 of FIG. 3 in that desalination system 80 also uses a series of evaporators 20, each operating at a different salt concentration. In this particular embodiment however, each compressor 24 services multiple evaporators 20. In this particular embodiment, each compressor 24 services two water evaporators 20. Additionally, the water evaporators 20 serviced by a single compressor 24 may operate at different temperatures. This may be facilitated by the use of countercurrent heat exchangers 22 between the stages serviced by a single compressor 24.

FIG. 5A is a side elevational cross-sectional view of one embodiment of a compressor that may be used with the embodiments of FIGS. 1 through 4; and FIGS. 5B and 5C are examples of different types of impellers that may be used with the compressor of FIG. 5A. The compressor 24 may be used with the desalination systems 10, 60, 70, and 80 described above. Depending on the embodiment, the compressor 24 may be designed for relatively low pressures but high velocities. The compressor 24 may have a converging pipe section 24a, and a diverging pipe section 24b that are coupled together at a throat section 24c. This may be similar to a venturi. An impeller 24d is provided to generate flow through the compressor 24. The impeller 24d may be a propeller 24d′ or a ducted fan 24d″. Additionally, a flow straightener 24e may be provided to remove energy-robbing rotational movement of the vapor. To save development costs, the propeller 24d′ or ducted fan 24d″ may be adapted from aerospace applications. For example propeller 24d′ may be a propeller used on a prop plane and ducted fan 24d″ may from a jet engine. This may be accomplished by adjusting the evaporator pressure such that the density of the vapor is similar to air at the altitude where the propeller 24d′ or ducted fan 24d″ is designed to operate. Regardless of the type of impeller 24d that is used, compressor 24 may use impeller 24d to accelerate the flow of vapor so that it is moving at a high velocity. Because the flow straightener 24e is downstream of the impeller 24d, it may be able to reduce the amount of spin in the vapor. This may be desirable because often the rotary motion is wasted energy that provides little to no benefit. As the vapor moves past the flow straightener 24e, the diameter of the compressor 24 begins to increase and so the velocity of the vapor begins to slow down. This decrease in velocity is converted into pressure energy.

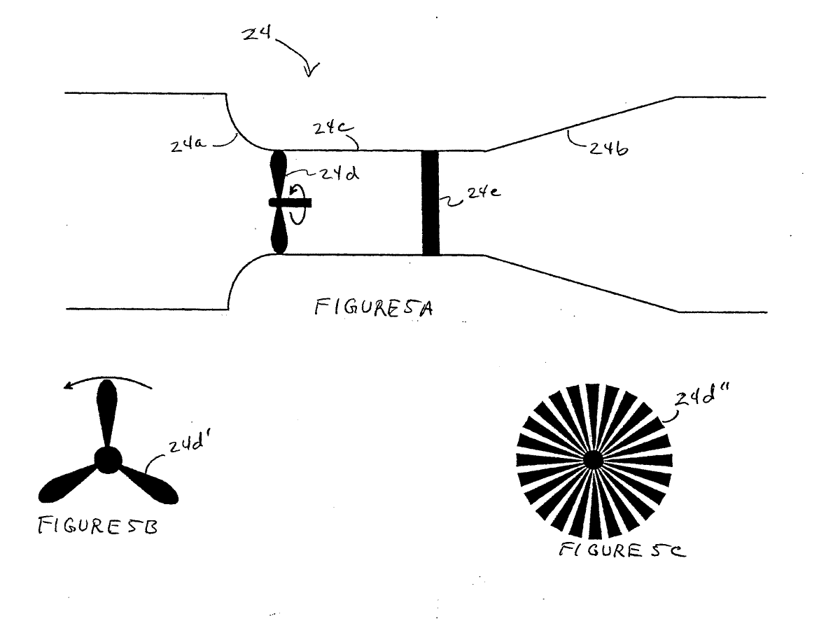

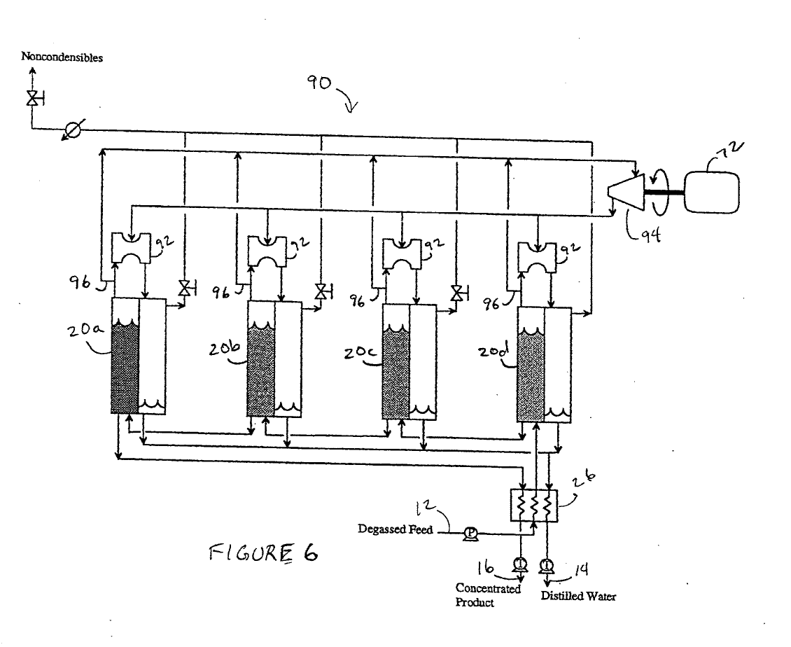

FIG. 6 is a schematic diagram of another desalination system using multiple jet ejectors as vapor sources, in accordance with particular embodiments. The degassed feed input 12, water output line 14, concentrated brine output line 16, and water evaporators are similar to the embodiment of FIG. 1. The desalination system 90 differs however in that each of the compressors are implemented using jet ejectors 92. In certain embodiments, jet ejectors 92 may be advantageous in that they can compress large volumes of vapor, which allows the evaporator system 90 to operate at reduced temperatures and pressures. This reduces vessel costs and reduces the size of the sensible heat exchanger that pre-heats the feed water with exiting brine and distilled water. The motive energy required by each jet ejector 92 is supplied by a mechanical compressor 94. As shown in FIG. 6, the inlet vapors to the mechanical compressor 94 are supplied from a lower-pressure fluid line 96 from each of the jet ejectors 94. In particular embodiments the compressor 94 may receive lower-pressure fluid from the lower-pressure fluid line 96 and compress it at a five or six to one ratio. This high-pressure vapor is then introduced into the throat of the jet ejector 92. The high-pressure vapor is what is used to generate the necessary compression for the respective evaporator 20.

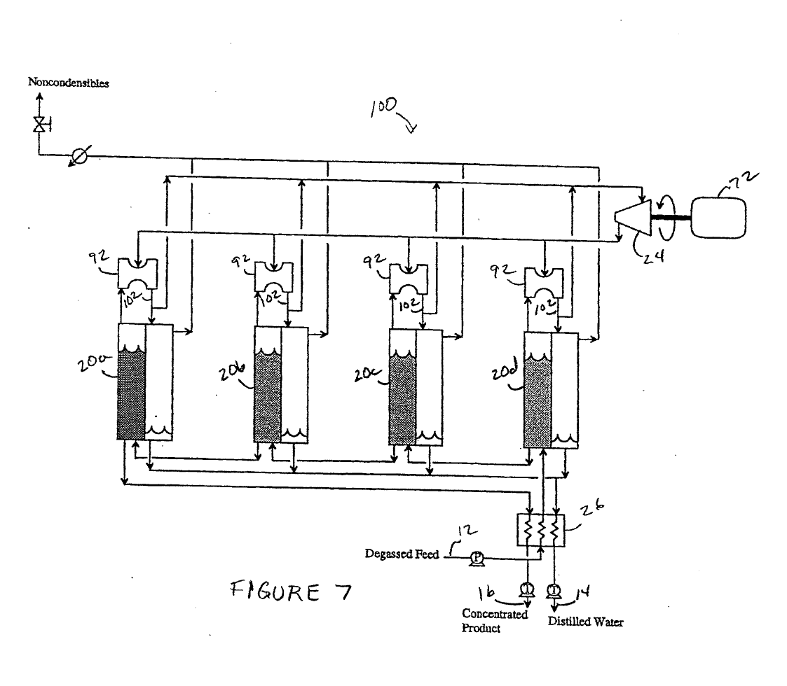

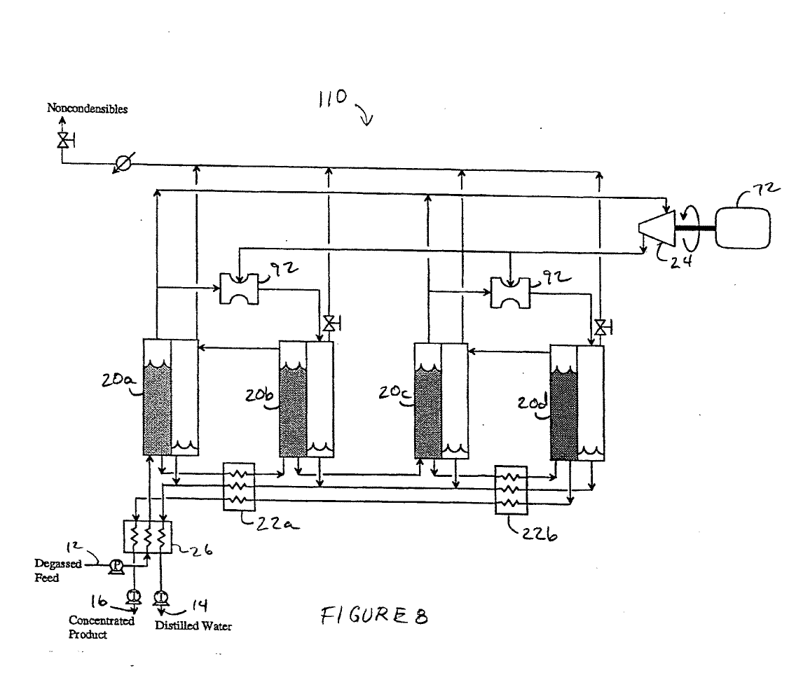

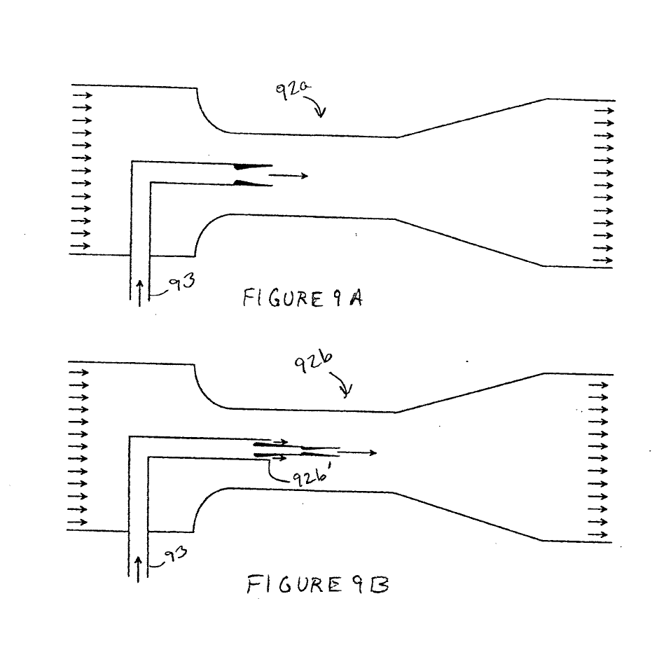

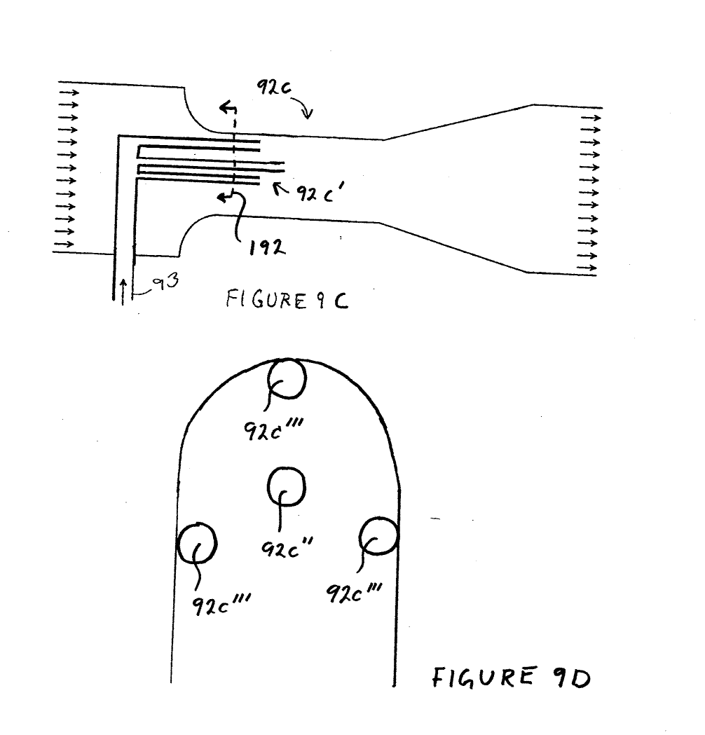

FIG. 7 is a schematic diagram of another desalination system using multiple jet ejectors as vapor sources, in accordance with particular embodiments. Desalination system 100 is similar to desalination system except that the compressor 24 is fed by a higher-pressure line 102 from each of the jet ejectors 92. In other words, the jet ejectors 92 may help to pre-compress the steam that is going into the compressor 24. One possible benefit of this may be that it makes the size/power requirements of compressor 24 a little smaller because the vapor going into it is already slightly pre-compressed.

FIG. 8 is a schematic diagram of another desalination system using multiple jet ejectors as vapor sources, in accordance with particular embodiments. The degassed feed input 12, water output line 14, concentrated brine output line 16, and water evaporators are similar to the embodiment depicted in FIG. 1. In this particular embodiment however, each jet ejector 92 services multiple evaporators 20. Additionally, the water evaporators 20 serviced by a single compressor may operate at different temperatures. This may be facilitated by the use of countercurrent heat exchangers 22 between the stages serviced by a single jet ejector 92.

FIGS. 9A-9C are side elevational cross-sectional views of different jet ejectors that may be used with the embodiments of FIGS. 6 through 8 and FIG. 9D is a front cross-sectional view along line 192 of FIG. 9C. The jet ejectors depicted in FIGS. 9A-9C generally include two inlets and one outlet. The first inlet is located on the left side of the jet ejector 92 and receives low-pressure, low-speed vapor. The second inlet provides the high-pressure, high-speed vapor from the input line 93. These two inputs mix within the constricted throat of the jet ejector 92 and produce a vapor output having a pressure and speed that is between that of the vapor from the two inputs. Jet ejectors 92 may have relatively high efficiencies when they are compressing at a 1.03 or a 1.05 to one compression ratio.

The jet ejector depicted in FIG. 9A shows a constant-area jet ejector 92a where the motive fluid is fed in a single step. The motive fluid may be supplied through input line 93. In particular embodiments the motive fluid may be high-pressure vapor.

FIG. 9B shows another embodiment of a jet ejector 92b having a two-step nozzle 92b′ that is adapted to allow progressive addition of the motive fluid. The two-step nozzle 92b′ may be more efficient than the single-step nozzle depicted in FIG. 9A. The two-step nozzle 92b′ allows the high-pressure vapor to be introduced in two stages, which reduces the velocity difference between the low-speed vapor entering the jet ejector 92 from the left and the high-speed vapor entering through the two-step nozzle 92b′. Thus the first stage of the two-stage nozzle may help to pre-accelerate the low-speed vapor before it reaches the second stage. Although two stages are shown in FIG. 9B, other embodiments may use additional stages.

FIG. 9C depicts another jet ejector 92c using a two-step nozzle 92c′. The two-step nozzle 92c′ includes four individual nozzle tips, center nozzle tip 92c″ and perimeter nozzle tips 92c″′. As can be seen in FIG. 9D the center nozzle tip 92c″ is surrounded by three equally spaced perimeter nozzle tips 92c″′. The center nozzle tip 92c″ extends farther downstream than the perimeter nozzle tips 92c″′. Thus, high-pressure vapor is released in two steps, first through the perimeter nozzle tips 92c″′ and then downstream through the center nozzle tip 92c″. While three perimeter nozzle tips 92c″′ are depicted other embodiments may use more or fewer perimeter nozzle tips. Furthermore, some embodiments may stagger the nozzle tips differently, for example, the center nozzle tip 92c″ may be upstream of the perimeter nozzle tips 92c″′ or all four nozzle tips may be of the same length (e.g., they all extend into the jet ejector 92 an equal distance).

FIG. 10A is a plan cross-sectional view of an evaporator and FIG. 10B is a side elevation cross-sectional view of an evaporator, in accordance with particular embodiments. The heat exchangers 22 may be contained within an enclosed pipe 120. In this particular embodiment, the heat exchanger 26 may be distributed through each of the water evaporators 20 such that efficient evaporation of water vapor from each of the water evaporators 20 may occur. As shown in FIG. 10D, degassed feed input line 12 provides an entry point for salt water. As the water is vaporized in the water evaporators 20, a port 98′ is provided that provides an outlet for the distilled water vapor. Liquid pump 24 is provided to route salt water from the degassed feed input line 12 to each of a plurality of jet ejectors 92. The jet ejectors 92 may induce some flow within the salt water to help move the liquid. This may help with the transfer of heat and allow for the water evaporator to be smaller. Using this process, water may be vaporized from the salt water in order to obtain distilled water.

FIG. 10A shows a path that may be taken by water vapor through the water evaporators 20. Steam entering through port 98″ passes through the plates causing the salt water to heat up and boil. In bringing the salt water to a boil the steam follows a zig-zag path through evaporator 20, eventually exiting as condensed water through an outlet (e.g., outlet 14 of FIG. 11). As the steam progresses from left to right, the baffles get closer and closer together. This may help maintain a relatively constant velocity (e.g., around 5 ft/s) despite losing steam from condensation. As the steam passes through the baffled heat exchanger plates and water condenses, the vapor phase may become enriched with noncondesibles. These noncondesibles may be purged through exit 74. Thus, distilled water vapor from the water evaporators 20 may be used to heat salt water in the subsequent water evaporators 20. A distilled water output line (e.g., outlet 14 of FIG. 11) provides an outlet for condensed distilled water from the desalination system.

FIG. 11 is a front elevation cross-sectional view of an evaporator, in accordance with particular embodiments. The upper 122 and 124 lower quadrants contain lower-pressure salt water and the left 128 and right 130 quadrants contain higher-pressure vapor and distilled water. Water evaporates from the salt and exits from the top through exit 98′. The pressure difference between the lower-pressure salt water and the higher-pressure water vapor may be supplied by a compressor or jet ejector (not specifically shown in FIG. 11). The left 128 and right 130 quadrants are supplied with higher-pressure steam, which condenses inside the plates. The condensate collects at the bottom of the left 128 and right 130 quadrants and exits through port 14. In one embodiment, the corners of the heat exchanger plates may be sealed to the pipe using inflatable gaskets.

FIG. 12A shows the water evaporators 20 and jet ejectors 92 removed from the enclosed pipe 120. FIG. 12B shows a side elevational cross-sectional view of the jet ejectors 92 of FIG. 12A that circulates liquid water through the heat exchangers, which may increase heat transfer.

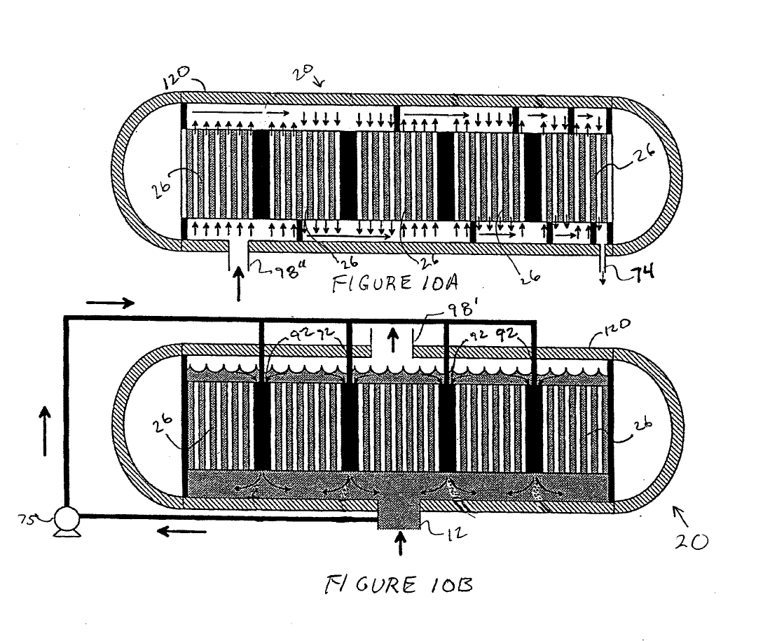

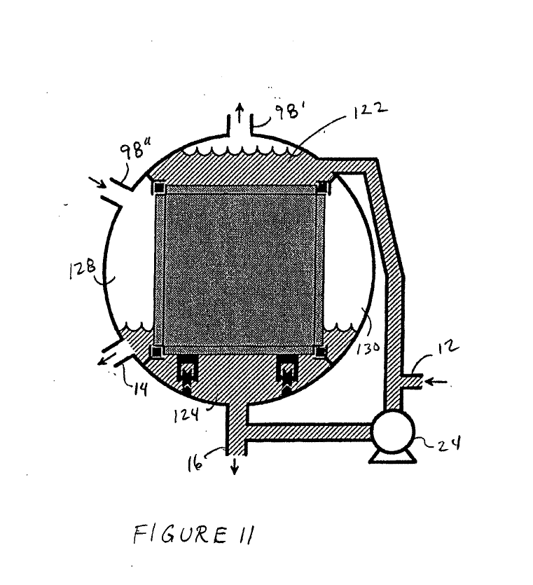

The integrated water evaporator 20 and heat exchanger 26 will now be described. FIG. 13A shows a metal sheet 140 that may be used to form a portion of the integrated water evaporator 20 and heat exchanger 26 of FIG. 12. Metal sheet 140 is shown in FIG. 13A having been cut into its desired shape and a number of dimples 142 formed therein. Additionally, tabs 146 are integrally formed in the four corners of the metal sheet 140. FIG. 13B shows the metal sheet 140 of FIG. 13A in which bends have been formed in the sheet 140 along dotted lines 144. FIGS. 13C and 13D show cross-sectional views of the sheet 140 taken along the lines 13C and 13D respectively.

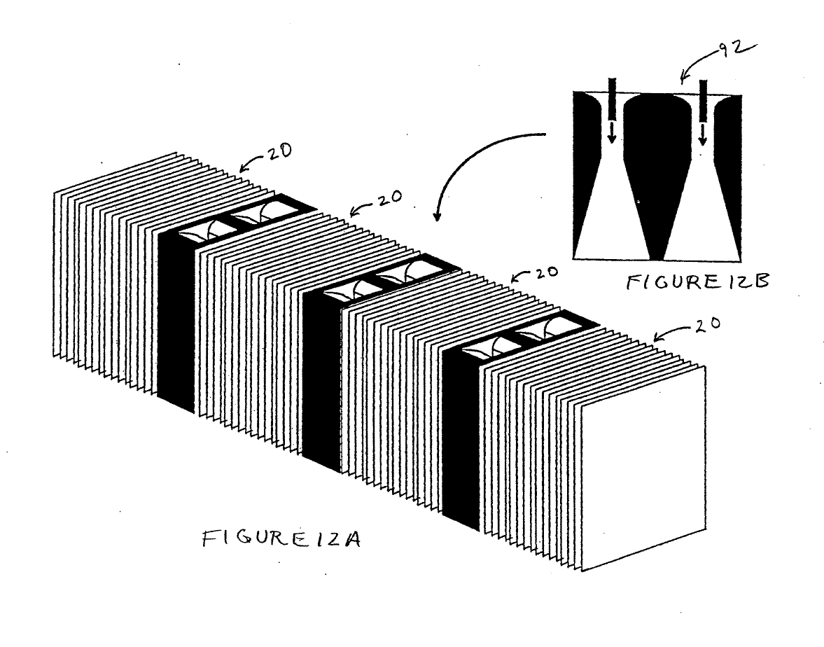

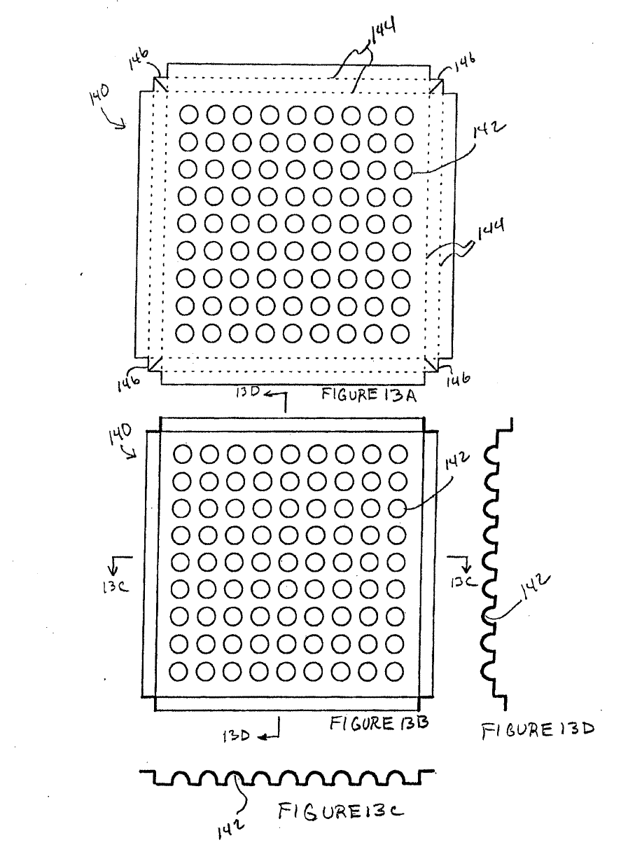

FIG. 14A through 14D shows another embodiment of a sheet 150 of metal that may be used to form the water evaporator 20 and heat exchanger 26 of FIG. 12. Metal sheet 150 is identical to metal sheet 140 except that no tabs exist at the corners of the sheet 150. Metal sheet is shown in FIG. 14A having been cut into its desired shape and a number of dimples 152 formed therein. FIG. 14B shows the metal sheet 150 of FIG. 14A in which bends have been formed in the sheet 150 along dotted lines 154. FIGS. 14C and 14D show cross-sectional views of the sheet 150 taken along the lines 14C and 14D, respectively.

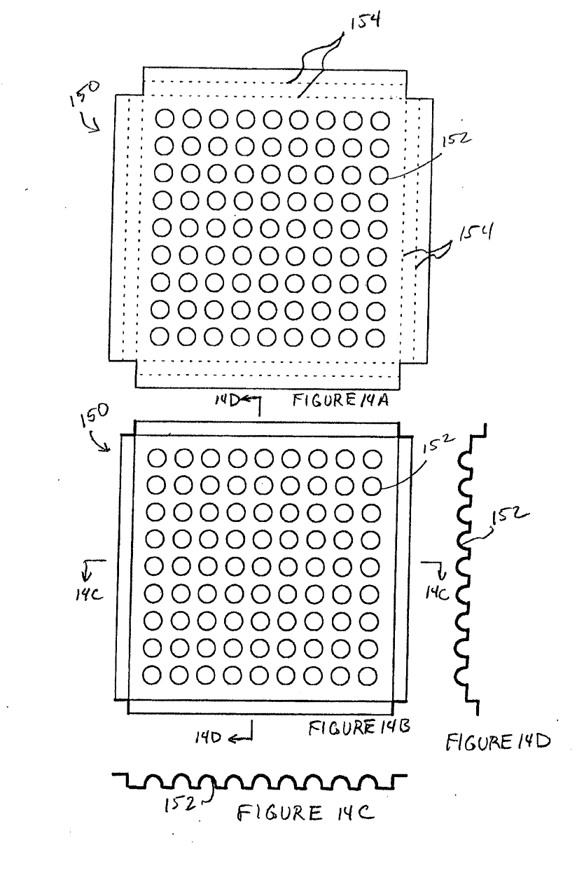

FIG. 15A shows an assembled portion of the water evaporator 20 and heat exchanger 26 of FIG. 13 that has been constructed using a number of metal sheets 140 that have been stacked, one upon another. FIG. 15B shows an enlarged, partial view of FIG. 15A depicting the structure formed by each of the tabs 146. FIG. 15C shows an enlarged side elevational view of FIG. 15A.

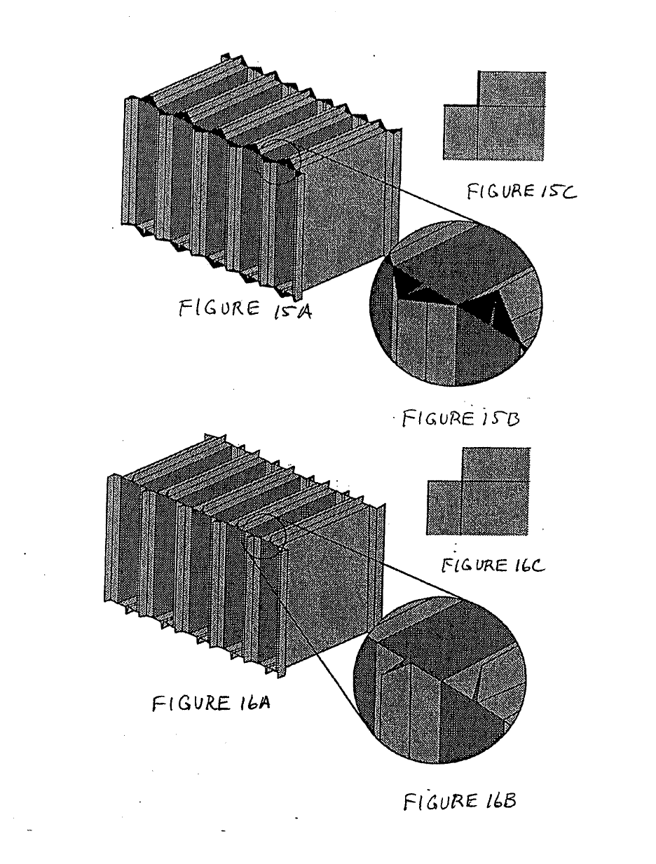

FIG. 16A shows an assembled portion of the water evaporator 20 and heat exchanger 26 of FIG. 14 that has been constructed using a number of metal sheets 150 that have been stacked, one upon another. FIG. 16B shows an enlarged, partial view of FIG. 16A depicting a corner portion of two mating sheets 150. FIG. 16C shows an enlarged side elevational view of FIG. 16A.

FIG. 17A shows one embodiment of a dimple shape 142 or 152 that comprises one aspect of the present invention. As shown, each of the dimples 142 or 152 has a flat region 156 such that, when another sheet 140 or 150 is placed adjacent thereto, there is no tendency to slide sideways, which would occur if the tips were rounded or pointed. In another embodiment shown in FIG. 17B, the dimples 142 or 152 of one sheet 140 or 150 may be formed with a depression 158 that is adapted to conform to the outer contour of another mating dimple 142 or 152 from another sheet 140 or 150.

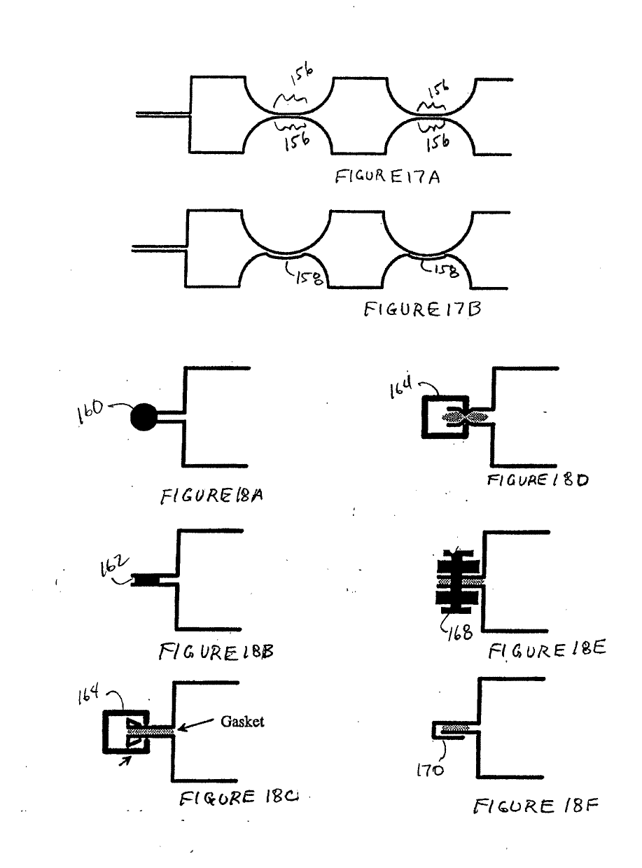

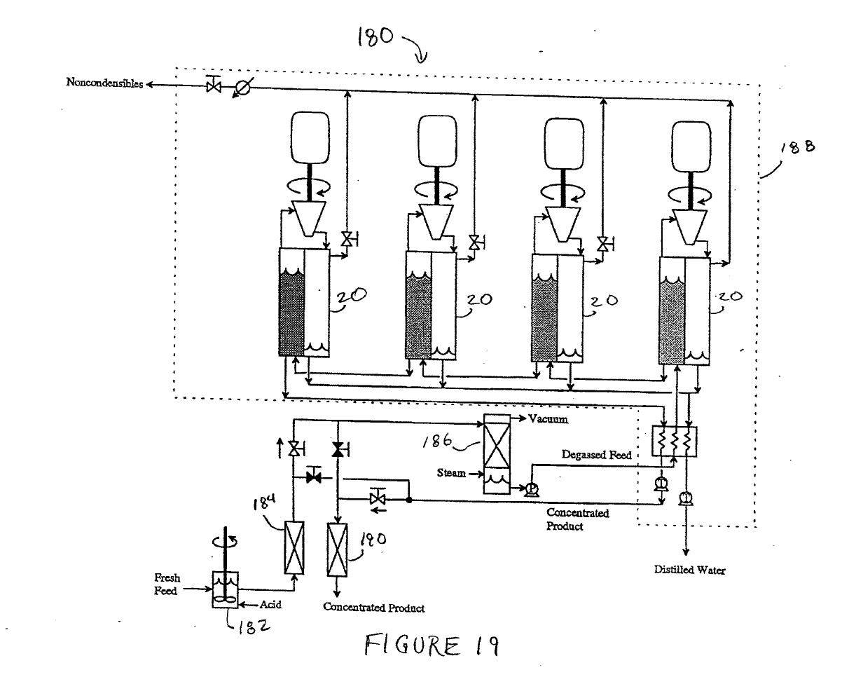

FIGS. 18A through 18F show various types of joints that may be used to attach one sheet 140 or 150 to another. FIG. 18A shows a welded joint 160. FIG. 18B shows a brazed joint 162. FIG. 18C shows a crimp clamp 164 that is used to attach the ends together. FIG. 18D shows another embodiment of a crimp clamp 164, wherein the edges of the sheet 140 or 150 are raised so the crimp clamp is securely held in place. FIG. 18E shows a rivet or screw 168 that is used to attach the edges of the sheets 140 or 150 together. FIG. 18F shows a tab 170 that is integrally formed on the edge of one sheet 140 or 150. During assembly, this tab is bent around the edge of an adjoining sheet 140 or 150.

FIG. 19 is a schematic diagram of a desalination system using an ion exchange system, in accordance with particular embodiments. Desalination system 180 provides an ion exchange system that selectively removes sulfate ions. Example resins that may be operable to remove sulfate ions are Purolite A-830W (available from Purolite Company) and Relite MG1/P (available from Residdion S.R.L., Mitsubishi Chemical Company).

In FIG. 19, acid is added to the fresh feed in mixing bin 182 to lower the pH. Any suitable acid material may be used, such as hydrochloric acid, phosphoric acid, or sulfuric acid. In one embodiment, sulfuric acid may be used due to its relatively low cost. The pH exiting the mixer is approximately 3 to 6. This acidified water is added to the exhaustion ion exchange bed 184, which is loaded with chloride ions. As the salt water passes through the exhaustion ion exchange bed 184, sulfate ions bind and chloride ions release. Approximately 95% removal of sulfate ions is possible. The pH exiting the exhaustion ion exchange bed 184 is approximately 5.0 to 5.2. This de-sulfonated water flows to a vacuum stripper 186 where dissolved carbon dioxide is removed; low-pressure steam is added as a carrier case. In some embodiments, other degassing technologies can be used, such as devices that use a vacuum to pull gases across a membrane. The liquid exiting the vacuum stripper 186 has a pH of approximately 7.0 to 7.2. It contains a low concentration of sulfate and carbonate ions, which reduces scaling problems in the heat exchangers. The degassed salt water flows into a desalination system 188. Many differing types of desalination systems can be employed, such as desalination systems 10, 60, 70, 80, 90, 100, or 110. FIG. 19 however, is shown using the desalination system 70. The concentrated brine water exiting the evaporators 20 is used to regenerate the regeneration ion exchange bed 190. Typically, the brine water concentration is 2.5 to 4.0 times more concentrated than the feed salt water.

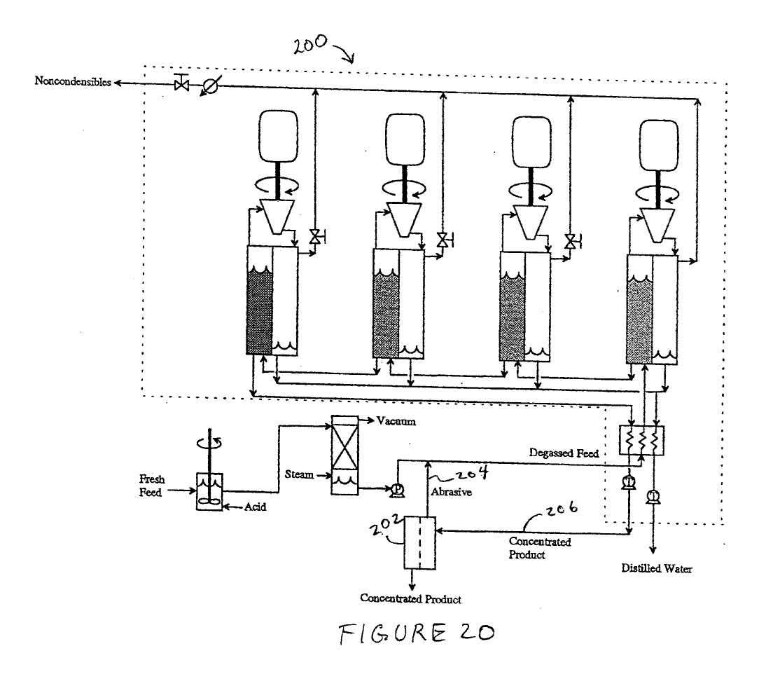

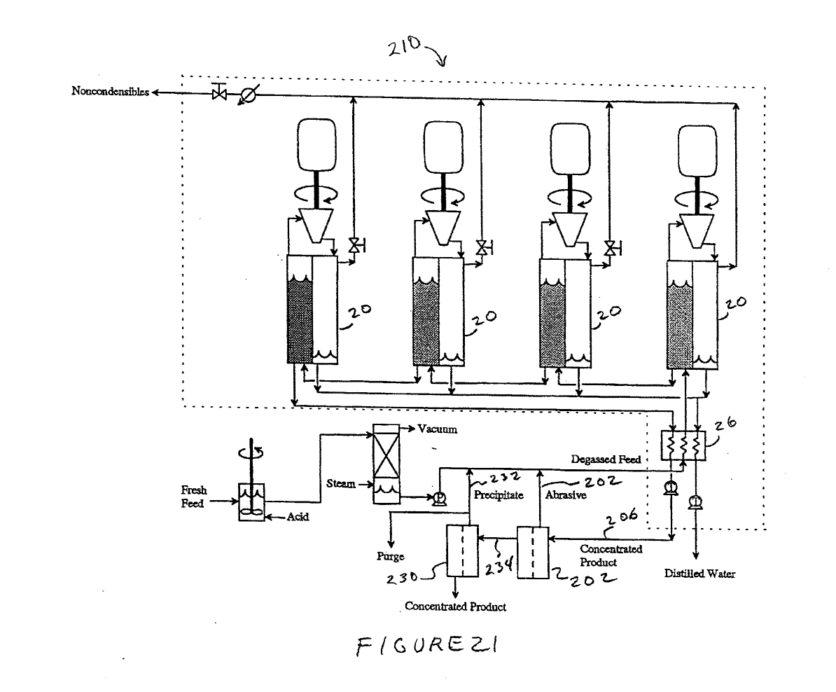

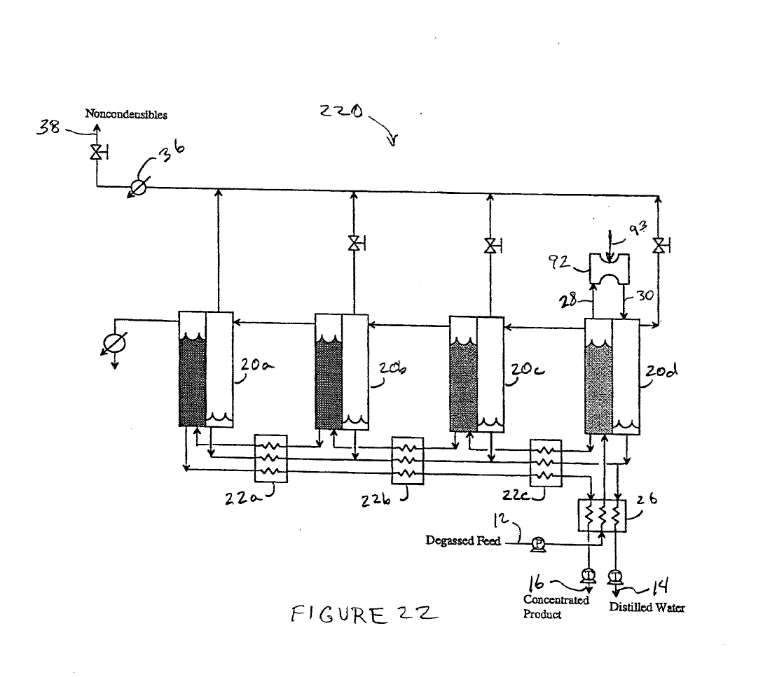

FIG. 20 is a schematic diagram of a desalination system using an abrasive material, in accordance with particular embodiments. Desalination system 200 may be operable to reduce scale formation on heat exchanger surfaces by including an abrasive material, such as small rubber balls, or small pieces of chopped wire with the salt water. The abrasive material may be introduced into the salt water at line 204 and is recovered from the concentrated brine water at line 206 using an abrasive material separator 202, which employs appropriate methods, such as filtration, settling, or magnets.

FIG. 21 is a schematic diagram of a desalination system using an abrasive material and a precipitate material, in accordance with particular embodiments. Desalination system 210 provides two systems to reduce scale formation on the water evaporator 20 and heat exchanger 26 inner surfaces. In one embodiment, an abrasive material separator 202 may be implemented that functions in a similar manner to the abrasive material separator 202 of FIG. 20. Particular embodiments, provide a precipitate separator 230 that distributes precipitate material into the salt water at line 232 and recovers the precipitate from line 234. Adding small particles of precipitate into the salt water to act as seed crystals that provide nucleation sites. As the salt solution supersaturates, rather than precipitation occurring on the metal surfaces, the precipitate will prefer to form on the seed crystals because the surface area is so much larger than the metal surface. Also, unlike the metal surface, the seed crystals have a crystalline structure similar to the newly formed precipitate, which eases the formation of the precipitate onto the seed crystal rather than the metal surface. The precipitate is removed by an appropriate method (e.g., filtration, centrifugation) in separator 230. A portion of the precipitate is returned as seed crystals and excess is purged from the system.

FIG. 22 is a schematic diagram of a desalination system in which the vapor leaving the final evaporator is condensed and discharged, in accordance with particular embodiments. The desalination system 220 is adapted to accept salt water at a salt water intake line 12, distill at least a portion of distilled water from the salt water, and provide distilled water at distilled water output line 14 and concentrated brine at concentrated brine output line 16. The water desalination system 220 has several water evaporators 20, several heat exchangers that are coupled in between each of the water evaporators 20, and a jet ejector 92 that is coupled to one of the water evaporators 20d (which may function as a vapor-compression evaporator). Pressurized vapor may be supplied to the other water evaporators 20a, 20b, and 20c in a cascading fashion such that each successive water evaporator 20a, 20b, and 20c (which may function as multi-effect evaporators) has a relatively lower operating pressure than the upstream water evaporator 20d. In this manner, water may be progressively removed or evaporated from the salt water.

As shown, degassed salt water is introduced into the degassed water feed input 12 and into a countercurrent heat exchanger 26 that has concentrated brine and distilled water flowing in the opposite direction. The degassed salt water enters a first water evaporator 20d where a portion of the water vaporizes. The remaining salt water is pumped through a countercurrent heat exchanger 22c into the second water evaporator 20c where additional water is vaporized. This process is repeated as many times as desired. As shown, a total of four water evaporators 20a, 20b, 20c, and 20d are shown; however, any quantity of water evaporators 20 may be used.

High-pressure steam, such as may be supplied from a boiler, enters the jet ejector 92 through line 93 and provides the motive energy needed to compress water vapor from the inlet line 28 to the output line 30. Output line 30 is coupled to water evaporator 20d. Thus, high pressures resulting in the water evaporator 20d causes water vapor to condense. As these vapors condense, they cause water to evaporate from the salt water. These vapors condense in the next evaporator 20c, which is operated at a lower pressure. This process is repeated for all of the other evaporators 20b, and 20a configured in the system.

Any noncondensibles that enter with the salt water intake line 12 may be purged from the system. As shown in FIG. 22, it is assumed that all heat exchangers operate above 1 atmosphere (atm), so the noncondensibles can be directly purged. If the system were operated below 1 atmosphere, a vacuum pump (not specifically shown) may be needed to remove the noncondensibles. In either case, a condenser 36 is located before the purge so that water vapor can be recovered before the noncondensibles are removed. Jet ejector 92 serves to pressurize water vapor from intake line 28 to output line 30.

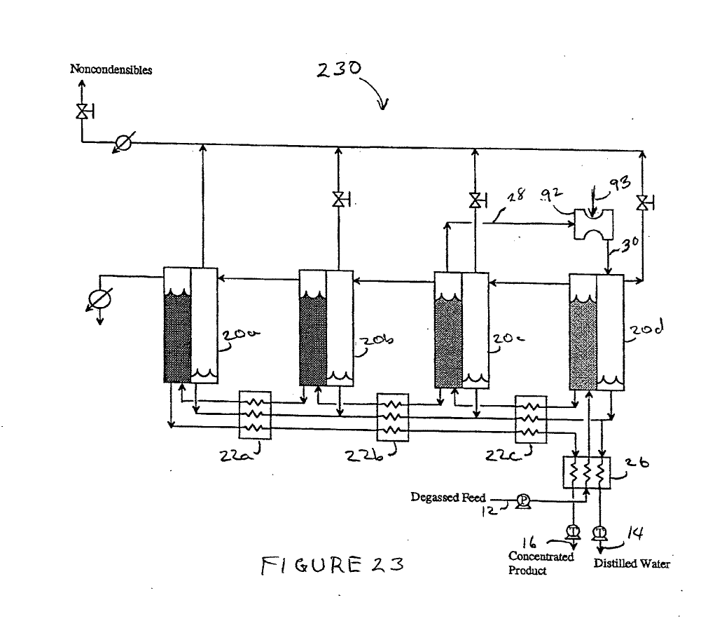

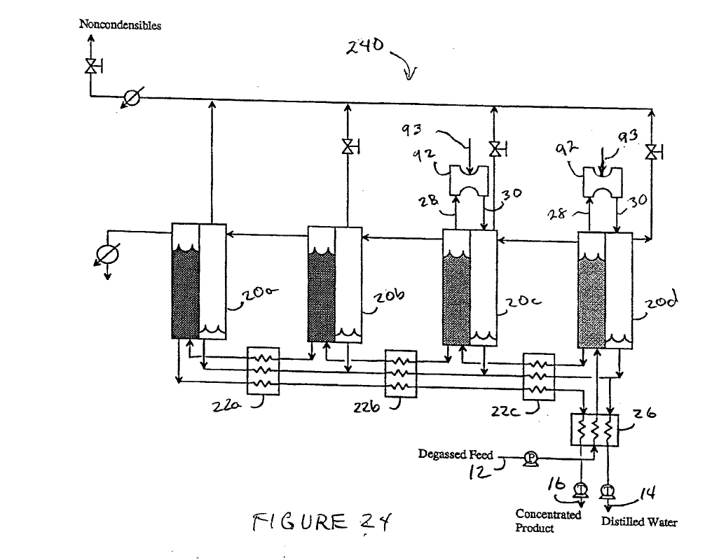

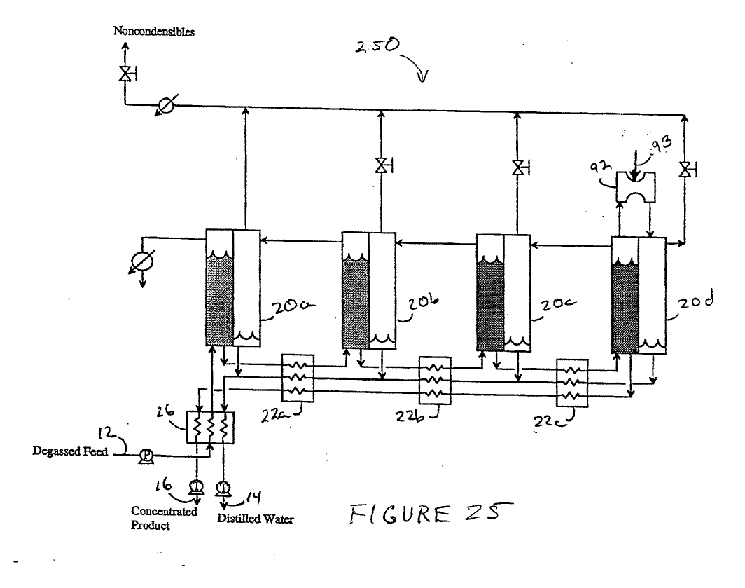

FIG. 23 is a schematic diagram of another desalination system in which the vapor leaving the final evaporator is condensed and discharged, in accordance with particular embodiments. The salt water intake line 12, water output line 14, concentrated brine output line 16, water evaporators 20, heat exchangers 22, and jet ejector 92 are similar to the desalination system 210 of FIG. 22. The desalination system 230 differs however in that the input line of the jet ejector 92 is coupled to the second water evaporator 24c.

FIG. 24 is a schematic diagram of a desalination system using two vapor sources in which the vapor leaving the final evaporator is condensed and discharged, in accordance with particular embodiments. This embodiment is similar to the desalination system 210 of FIG. 22 in that desalination system 240 also uses a series of evaporators 20, each operating at a different salt concentration. In this particular embodiment however, several water evaporators 20c and 20d have their own dedicated jet ejector 92. In FIG. 24 the first 20d and second 20c water evaporators are each shown with their own dedicated jet ejector 92. However, it may be appreciated that any of the water evaporators 24a, 24b, 24c, or 24d may be configured with their own jet ejectors 92.

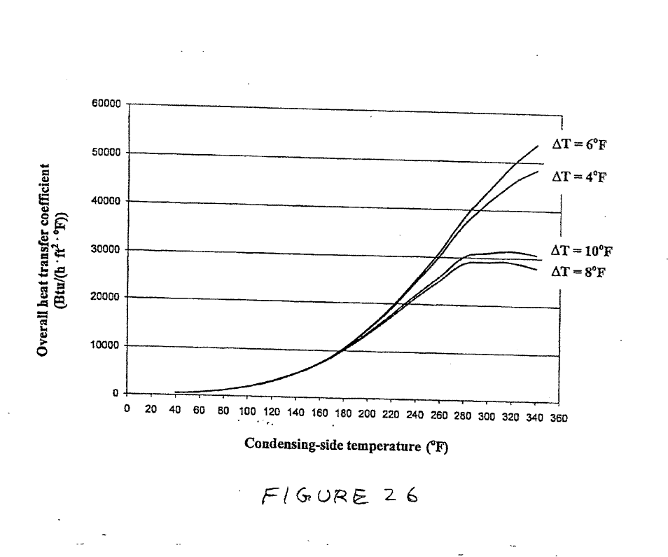

FIG. 25 is a schematic diagram of a desalination system in which the vapor leaving the initial evaporator is condensed and discharged, in accordance with particular embodiments. The salt water intake line 12, water output line 14, concentrated brine output line 16, and water evaporators 20 are similar to the desalination system 210 of FIG. 22. The desalination system 250 differs however in that degassed feed line 12 is coupled to water evaporator 20a that is not directly coupled to the jet ejector 92. That is, degassed feed line 12 is coupled to a subsequent water evaporator 20a that is downstream from the cascaded water evaporator 20 train.

FIG. 26 is a graph showing the overall heat transfer coefficient as a function of condensing-side temperature and the overall temperature difference between the condensing steam and boiling water. The graph shows the overall heat transfer coefficient as a function of condensing-side temperature and the overall temperature difference (ΔT) between the condensing steam and boiling water. This graph shows that the overall heat transfer coefficient rises dramatically as condensing-side temperatures increase to about 340° F. Above this temperature, it is difficult to maintain drop-wise condensation, which has dramatically better heat transfer than film-wise condensation. Drop-wise condensation is promoted with a hydrophobic surface (e.g., gold, chrome, silver, titanium nitride, Teflon). A preferred hydrophobic surface is created by covalently bonding a monolayer of hydrophobic organic chemicals directly to the surface of a metal (copper) heat exchanger using diazonium chemistry.

Above 248° F. (120° C.), there is a tendency for seawater to deposit scale onto heat exchanger surfaces. In general, it is desirable that the saltwater side of the heat exchanger should be nonstick. Above 248° F. (120° C.), a non-stick surface is particularly useful if calcium, magnesium, sulfate and carbonate ions are present in the water. If the heat exchanger is made from titanium, it naturally has a nonstick surface. It is also possible to coat metal with nonstick surfaces, such as the following:

a. Teflon coating onto metal. DuPont Silverstone Teflon coatings used for cookware can sustain temperatures of 290° C.

b. Aluminum can be hard anodized followed by PTFE (polytetrafluoro ethylene) inclusion.

c. Vacuum aluminization of carbon steel, followed by hard anodizing and PTFE inclusion.

d. Impact coating of aluminum, carbon steel, or naval brass with PPS (polyphenylene sulfide) or PPS/PTFE alloy.

e. titanium nitride, titanium carbide, or titanium boride applied by physical vapor deposition.

Such coatings would be applied to the side of the heat exchanger that is exposed to the hot saltwater. Ideally, the base metal would consist of a saltwater-resistant material, such as naval or admiralty brass. Using this approach, should the coating fail, the heat exchanger may foul but it would not perforate or leak.

At lower temperatures (<ca. 120° C.), the nonstick surface may not be necessary; however, saltwater resistance can be imparted by cathodic-arc vapor deposition of titanium on other metals, such as aluminum or carbon steel.

As an alternative to coating the metal surface, it is possible to bond a thin polymer film—such as PVDF (polyvinylidenedifluoride) or PTFE—using adhesives and/or heat lamination.

If fouling does occur, the heat exchanger could be taken out of service temporarily to clean the surfaces with dilute acids or other appropriate cleaners.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

1-44. (canceled)

45. A method for desalinating a brine solution comprising:
receiving a brine solution;
heating the brine solution prior to the non-distilled water entering a first evaporator of a plurality of evaporators;
distilling the brine solution into a portion of distilled liquid and a reduced amount brine solution, the reduced amount of brine solution being more concentrated than the brine solution prior to entering the first evaporator;
pumping the reduced amount of brine solution through the plurality of evaporators;
wherein pumping the reduced amount of brine solution through the plurality of evaporators comprises:
heating the reduced amount of brine solution prior to the reduced non-distilled water entering a subsequent evaporator of the plurality of evaporators; and
distilling the reduced brine solution into a portion of distilled liquid and a further reduced amount brine solution, the further reduced portion of brine solution being more concentrated than the reduced amount of brine solution prior to entering the subsequent evaporator; and
upon a last evaporator of the plurality of evaporators distilling the further reduced portion of brine solution, discharging the further reduced portion of brine solution as concentrated product.

46. The method of claim 45, further comprising:
generating a first stream of vapor; transporting the first stream of vapor to the last evaporator of the plurality of evaporators; and
for each evaporator of the plurality of evaporators:
generating within the evaporator a second stream of vapor; and
transporting the second stream of vapor to a subsequent evaporator.

47. The method of claim 46, wherein generating a first stream of vapor comprises mixing within a compressor brine solution or distilled liquid with the vapor.

48. The method of claim 46, wherein generating a first stream of vapor comprises:
generating a high-pressure stream of vapor; and
combining within a jet ejector the high-pressure stream of vapor with a low-pressure stream of vapor from the last evaporator, the combination resulting in the first stream of vapor.

49. The method of claim 45, further comprising:
generating a first stream of vapor;
transporting the first stream of vapor to the first evaporator of the plurality of evaporators; and
for each evaporator of the plurality of evaporators:
generating within the evaporator a second stream of vapor; and
transporting the second stream of vapor to a subsequent evaporator.

50. The method of claim 45, wherein generating a first stream of vapor comprises mixing within a compressor brine solution or distilled liquid with the vapor.

51. The method of claim 45, wherein generating a first stream of vapor comprises:
generating a high-pressure stream of vapor; and
combining within a jet ejector the high-pressure stream of vapor with a low-pressure stream of vapor from the first evaporator, the combination resulting in the first stream of vapor.

52. The method of claim 51, further comprising agitating the brine solution within each evaporator of the plurality of evaporators with a plurality of jet ejectors within each evaporator of the plurality of evaporators.

53. The method of claim 51, further comprising exchanging ions within the brine solution in an ion exchanger before the brine solution enters any evaporator of the plurality of evaporators through which the.

54. The method of claim 53, further comprising mixing an acid solution with the brine solution before the brine solution enters the ion exchanger.

55. The method of claim 45, further comprising removing carbon dioxide from the brine solution before it enters any evaporator of the plurality of evaporators.

56. The method of claim 45, further comprising adding an abrasive material to the brine solution before it enters any evaporator of the plurality of evaporators.

57. The method of claim 45, further comprising adding a precipitate material to the brine solution before it enters any evaporator of the plurality of evaporators.

58-61. (canceled)
